(19) United States
(12) Patent Application Publication
(10) Pub. No.: US 2024/0123904 A1
(43) Pub. Date: Apr. 18, 2024

(54) DRIVING ASSIST APPARATUS

(71) Applicant: TOYOTA JIDOSHA KABUSHIKI KAISHA, Aichi (JP)

(72) Inventor: TAKASHI UNIGAME, Nagoya-shi (JP)

(21) Appl. No.: 18/461,508

(22) Filed: Sep. 6, 2023

(30) Foreign Application Priority Data
Oct. 18, 2022 (JP) 2022-166812

(51) Int. Cl. B60R 1/12; B60R 1/00; B60R 1/25

(52) U.S. Cl. CPC B60R 1/12; B60R 1/006; B60R 1/25; B60R 2001/1253

(57) ABSTRACT

A driving assist apparatus includes a photographing part mounted in side mirrors switchable between a first state where a driver can see a vehicle rear side and a second state where a protruding margin of the side mirrors in a width direction of the self-vehicle is small, and having different photographable areas between the first and second states. A control part performs a driving assist based on images photographed by the photographing part. The control part is configured to judge whether the side minors are in the first or second state based on the images, and to continue the driving assist when the side minors are judged to be in the first state and suspend the driving assist and notify to the driver that the driving assist is not carried out when the side minors are judged to be in the second state.

### TECHNICAL FIELD

The present invention relates to a driving assist apparatus.

### BACKGROUND ART

A surrounding monitoring apparatus which combines photographed images by a plurality of in-vehicle cameras to display the combined image on an in-vehicle display has been known (refer to Patent Literature 1 (PTL1)). In such an apparatus, side cameras which photograph sides of a vehicle are generally mounted as a unit in side mirrors, and photographing areas photographed by the side cameras change depending on an opening-and-closing state of the side mirrors. In a state where the side mirrors are closed, there is a possibility that images photographed by the side cameras may be unable to be fully utilized and original surrounding monitoring performance may be unable to be demonstrated.

In a case as the above, control in which a driving assist, such as surrounding monitoring, using images photographed by side cameras is suspended and the suspension is notified to a driver or control in which image processing for a driving assist is changed according to a difference between photographed images when side mirrors are opened and photographed images when the side mirrors are closed are needed. Therefore, in the prior art, an opening-and-closing state of side mirrors is detected based on a signal corresponding to a state of an opening-and-closing switch of the side mirrors, and the above-mentioned control is performed based on the detection result.

### CITATION LIST

### Patent Literature

[PTL1] Japanese Patent Application Laid-Open (kokai) No. 2016-196217

### SUMMARY OF INVENTION

### Technical Problem

However, actually, a situation where the opening-and-closing state of side mirrors cannot be specified based on the signal corresponding to the state of the opening-and-closing switch of the side mirrors may arise. As such a situation, there is a situation in which the opening-and-closing state of side mirrors becomes unknown due to removal of a battery when the opening-and-closing switch of the side mirrors is a momentary switch, such as a pad type, and a storage media, such as nonvolatile memory, which memorizes a final state of the switch is not equipped, for example. Furthermore, the opening-and-closing state of side mirrors becomes unknown also in a case where side mirrors are opened and closed manually without using the opening-and-closing switch.

In a situation as the above, control as mentioned above cannot be performed appropriately. Although addition of a sensor for specifying an opening-and-closing state of side mirrors, etc. can be considered as a measure for such a problem, such a measure causes increase of cost. Accordingly, a technology by which an opening-and-closing state of side mirrors can be judged appropriately while maintaining a conventional configuration has been demanded.

Namely, one objective of the present invention is to appropriately judge an opening-and-closing state of side mirrors, appropriately notify to a driver propriety of a driving assist using photographed images by side cameras mounted in the side mirrors and appropriately perform continuation or suspension of the driving assist.

### Solution to Problem

As a result of diligent research, the present inventor has found out that the above-mentioned objective can be attained by distinguishing an opening-and-closing state of side mirrors automatically based on photographed images by side cameras, suspending a driving assist using images photographed by the side cameras and notifying the suspension to a driver when the side mirrors are judged to be closed.

Specifically, a driving assist apparatus according to the present invention is a driving assist apparatus comprising photographing means which photograph surrounding of a self-vehicle and a control part which performs a driving assist for a driver based on photographed images photographed by the photographing means. The photographing means are mounted in side mirrors which can be opened and closed between a first state where the driver can visually recognize rear sides of the self-vehicle and a second state where a protruding margin of the side mirrors in a width direction of the self-vehicle is small. Therefore, in the photographing means, photographable areas are different between in the first state and in the second state.

Furthermore, in the driving assist apparatus according to the present invention, the control part comprises a judgment part which judges whether the side mirrors are in the first state or in the second state based on the above-mentioned photographed images. In addition, in the driving assist apparatus according to the present invention, the control part is configured so as to continue the above-mentioned driving assist when the side mirrors are judged to be in the first state and suspend the above-mentioned driving assist and notify to the driver that the above-mentioned driving assist is not carried out when the side mirrors are judged to be in the second state.

### Advantageous Effects of Invention

As mentioned above, in the driving assist apparatus according to the present invention, whether the side mirrors are in the first state or in the second state is judged based on the photographed images photographed by the photographing means. Therefore, in accordance with the driving assist apparatus according to the present invention, an opening-and-closing state of the side mirrors can be appropriately judged, and propriety of a driving assist using the photographed images by the side cameras mounted in the side mirrors can be appropriately notified to a driver and continuation or suspension of the driving assist can be appropriately performed.

### BRIEF DESCRIPTION OF DRAWINGS

FIG. 1 is a schematic view for showing an example of photographed images photographed by side cameras when side mirrors are in a closed state (second state).

FIG. 2 is a schematic block diagram or showing an example of a functional configuration of a driving assist apparatus according to a first embodiment of the present invention (first apparatus).

FIG. 3 is a flow chart for showing an example of a flow of various processing in a routine carried out in the first apparatus.

FIG. 4 is a schematic block diagram for showing an example of a functional configuration of a driving assist apparatus according to a second embodiment of the present invention (second apparatus).

FIG. 5 is a flow chart for showing an example of a flow of various processing in a routine carried out in the second apparatus.

### DESCRIPTION OF EMBODIMENTS

### First Embodiment

Hereafter, a driving assist apparatus according to a first embodiment of the present invention (which may be referred to as a “first apparatus” hereafter) will be explained, referring to drawings.

<Configuration>

The first apparatus is a driving assist apparatus comprising photographing means which photograph surrounding of a self-vehicle and a control part which performs a driving assist for a driver based on photographed images photographed by the photographing means. The photographing means are mounted in side mirrors which can be opened and closed between a first state where the driver can visually recognize rear sides of the self-vehicle and a second state where a protruding margin of the side mirrors in a width direction of the self-vehicle is small. For this reason, in the photographing means, photographable areas are different between in the first state and in the second state.

As an example of the photographing means as mentioned above, a camera which is referred to as what is called a “side camera” etc., for example. Moreover, as examples of the driving assist performed by the first apparatus based on based on the photographed images photographed by the photographing means, a driving assist in which a warning of collision with a stationary object on a rear side and/or brake control for avoiding the collision with a stationary object on a rear side are carried out as well as a driving assist in which a pedestrian, a two-wheeled vehicle or a car, etc. moving around a self-vehicle is detected and an attention call by a warning, etc. is performed can be exemplified, for example.

Furthermore, in the first apparatus, the control part comprises a judgment part which judges whether the side mirrors are in the first state or in the second state based on the above-mentioned photographed images. Namely, in the first apparatus, although an opening-and-closing state of the side mirrors is not detected based on a signal corresponding to a state of an opening-and-closing switch of the side mirrors and no sensor for specifying the opening-and-closing state of the side mirrors is added, the opening-and-closing state of the side mirrors can be appropriately judged while maintaining a conventional configuration.

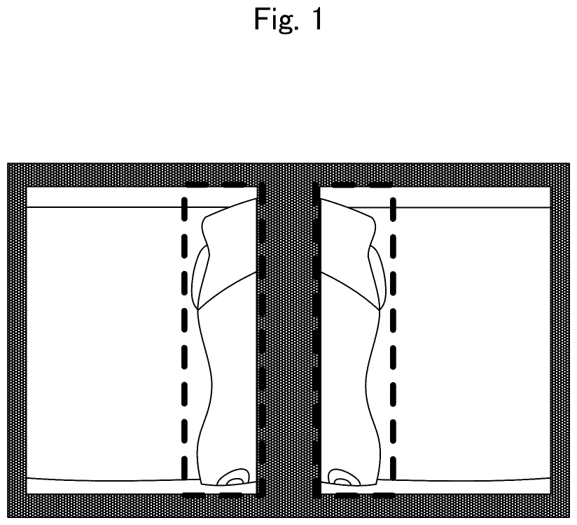

FIG. 1 is a schematic view for showing an example of photographed images photographed by side cameras when side mirrors are in the closed state (namely, the second state). As shown in the portion surrounded by a thick broken line illustrated in FIG. 1, when the side mirrors are in the second state, a part of a vehicle body of the self-vehicle is certainly reflected at a predetermined position. Therefore, when a part of a vehicle body of the self-vehicle is reflected at a predetermined position of the photographed images photographed by the photographing means mounted in the side mirrors, the side mirror can be judged to be in the second state.

In addition, a specific technique for judging whether side mirrors are in the first state or in the second state based on the above-mentioned photographed images is not particularly limited as long as it is possible to judge whether the side mirror are in the first state or in the second state. As an example of such a technique, a discrimination method using a pattern recognition technology including image recognition, etc. can be exemplified, for example. Details of such a technique will be mentioned in an explanation about other embodiments which will be mentioned later.

In addition, in the first apparatus, the control part is configured so as to continue the driving assist when the side mirrors are judged to be in the first state and suspend the driving assist and notify to the driver that the driving assist is not carried out when the side mirrors are judged to be in the second state. Namely, also in the first apparatus, similarly to the above-mentioned conventional technology, when the side mirrors are discriminated to be in the closed state, the driving assist using the photographed images by the side cameras is suspended and the suspension is notified to the driver.

However, in the first apparatus, as mentioned above, the judgment part judges whether the side mirrors are in the first state or in the second state based on the photographed images photographed by the photographing means.

In addition, functions of the first apparatus as mentioned above can be realized by an ECU mounted on the self-vehicle, for example. In the present specification, the “ECU” is an electronic control unit comprising a microcomputer as a principal part, and is referred to also as a “controller”. The microcomputer includes a CPU (processor), an ROM, an RAM, a nonvolatile memory and an interface, etc. The CPU is configured so as to realize various functions by performing instructions (a program, a routine) stored in the ROM. These various functions may be performed by one specific ECU which constitutes the first apparatus, or may be dispersively performed by a plurality of ECUs. In the latter case, a plurality of the ECUs can be configured as to be connected through a CAN (Controller Area Network), etc. to able to communicate mutually, for example.

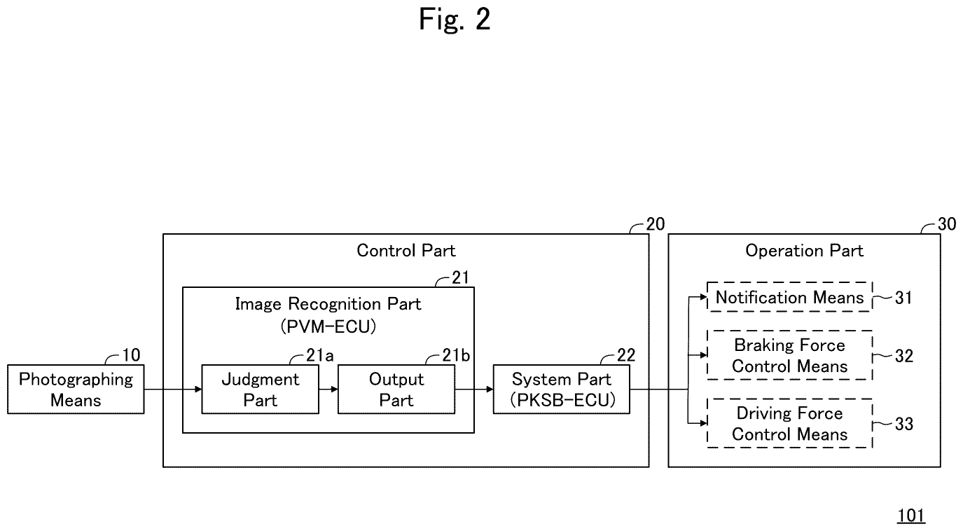

FIG. 2 is a schematic block diagram or showing an example of a functional configuration of a first apparatus. Namely, FIG. 2 exemplifies one configuration which can realize the functions performed by the first apparatus, and specific configurations of the first apparatus are not limited to the example shown in FIG. 2.

The first apparatus 101 exemplified in FIG. 2 is a driving assist apparatus comprising photographing means 10 which photograph surrounding of a self-vehicle and a control part 20 which performs a driving assist for a driver based on photographed images photographed by the photographing means 10. The photographing means are side cameras mounted in side mirrors (not shown) which can be opened and closed between a first state where the driver can visually recognize rear sides of the self-vehicle and a second state where a protruding margin of the side mirrors in a width direction of the self-vehicle is small. For this reason, in the photographing means 10, photographable areas are different between in the first state and in the second state.

In the first apparatus 101, the control part 20 is constituted by an image recognition part 21 and a system part 22. The image recognition part 21 is an electronic control unit (ECU) which controls a panoramic view monitor (PVM), and comprises a judgment part 21a and an output part 21b. The judgment part 21a judges whether the side mirrors are in the first state or in the second state based on the photographed images photographed by the photographing means 10. The output part 21b outputs a signal which indicates a judgment result by the judgment part 21a (namely, whether the side mirrors are in the first state or in the second state). The system part 22 is an electronic control unit (ECU) which controls a parking support brake, and the output part 21b performs an expected driving assist using an operation part 30 which will be mentioned later, based on the judgment result by the judgment part 21a outputted from the output part 21b.

Furthermore, the first apparatus 101 comprises the operation part 30, and the operation part 30 comprises a notification means 31, a braking force control means 32 and a driving force control means 33. The notification means 31 comprises a buzzer or a speaker, vibrator and/or an indicator, etc., for example, and performs notification to the driver by sound, light and/or generating of vibration as well as display of an image and/or a character, etc., respectively, based on an instruction signal from the system part 22. The braking force control means 32 and the driving force control means 33 control braking force by a brake, and driving force by an engine based on the instruction signal from the system part 22 to perform a warning of collision with a stationary object on a rear side and/or a driving assist for avoiding collision with the stationary object on the rear side, etc., for example.

In addition, in the first apparatus 101, the system part 22 which constitutes the control part 20 is configured so as to continue the driving assist based on the photographed images photographed by the photographing means 10 when the judgment part 21a judges the side mirrors to be in the first state and suspend the driving assist and notify to the driver that the driving assist is not carried out when the side mirrors are judged to be in the second state.

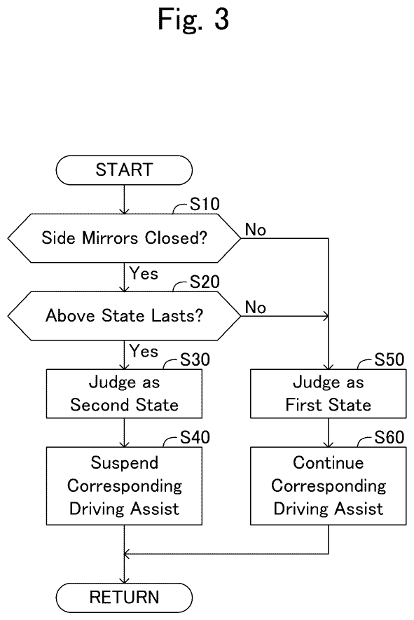

FIG. 3 is a flow chart for showing an example of a flow of various processing in a routine for carrying out the above-mentioned functions in the first apparatus 101. In the self-vehicles which is not shown, when an ignition key is set to ON, various control including the driving assist based on the photographed images photographed by the photographing means 10 is started. The routine expressed by the flow chart exemplified in FIG. 3 is also repeatedly performed at a predetermined short time interval (for example, 0.05 second).

Once the above-mentioned routine is started, in Step S10, the judgment part 21a judges whether the side mirrors are in the closed state or not, based on the photographed images photographed by the photographing means 10. In the example shown in FIG. 3, when the side mirrors are judged to be closed (Step S10: Yes), in the following step S20, whether the state where the side mirrors are judged to be closed continues for a predetermined time period or longer or not is judged. This is processing for judging more certainly whether the side mirrors are in the closed state or not, in consideration of a case where the side mirrors are temporarily misjudged to be in the closed state due to some sudden situation, for example.

When the state where the side mirrors are judged to be closed continues for the predetermined time period or longer (Step S20: Yes), in the following step S30, a signal indicating that the side mirrors are in the second state is sent to the system part 22 through the output part 21b from the judgment part 21a. Then, in the following step S40, the driving assist based on the photographed images photographed by the photographing means 10 is suspended the system part 22 and the suspension is notified to the driver by the notification means 31.

On the other hand, when the side mirrors are judged to be in the closed state (Step S10: No) or when the state where the side mirrors are closed does not continue for the predetermined time period or longer (Step S20: No), in the following step S50, a signal indicating that the side mirrors are in the first state is sent to the system part 22 through the output part 21b from the judgment part 21a. Then, in the following step S60, the driving assist based on the photographed images photographed by the photographing means 10 is continued by the system part 22.

<Effects>

As mentioned above, in the first apparatus, whether the side mirrors are in the first state or in the second state is judged based on the photographed images photographed by the photographing means. Therefore, in accordance with the first apparatus, an opening-and-closing state of the side mirrors can be judged appropriately even in a situation where the opening-and-closing state of the side mirrors cannot be specified based on the signal corresponding to the state of the opening-and-closing switch of the side mirrors, such as when a battery is detached and/or when the side mirrors are manually opened or closed, for example. As a result, propriety of the driving assist using the photographed images by the side cameras mounted in the side mirrors can be appropriately notified to a driver and continuation or suspension of the driving assist can be performed appropriately.

### Second Embodiment

Hereafter, the driving assist apparatus according to a second embodiment of the present invention (which may be referred to as a “second apparatus” hereafter) will be explained, referring to drawings.

<Configuration>

The second apparatus is the above-mentioned first apparatus, characterized by further comprising a storage part which previously stores memory images which are photographed images photographed by the photographing means when the side mirrors are in the second state. The memory images are photographed images photographed by the photographing means when the side mirrors are in the second state as mentioned above, and are photographed images photographed by the photographing means when the side mirrors are judged to be in the second state based on the judgment result by the judgment part and/or a state of an opening-and-closing switch of the side mirrors, etc., for example. Moreover, data stored in the storage part as the memory images may be photographed images photographed by the photographing means most recently, or may be average or typical images derived from a plurality of photographed images photographed in the past. In addition, the storage part may include what is called “data storage device”, such as a nonvolatile memory, for example, and the data storage device may be shared with the control part.

Furthermore, in the second apparatus, the judgment part is configured so as to judge that the side mirrors are in the second state when actual images which are photographed images photographed by the photographing means are judged to coincide with the memory images and judge that the side mirrors are in the first state when the actual images are judged not to coincide with the memory images. Namely, since the side mirrors are judged to be in the closed state when the actual images are judged to coincide with the memory images, the control part suspends the driving assist based on the photographed images photographed by the photographing means and notified to the driver that the driving assist is not carried out. On the other hand, since side mirrors are judged to be in the opened state when the actual images are judged not to coincide with the memory images, the control part continues the driving assist based on the photographed images photographed by the photographing means.

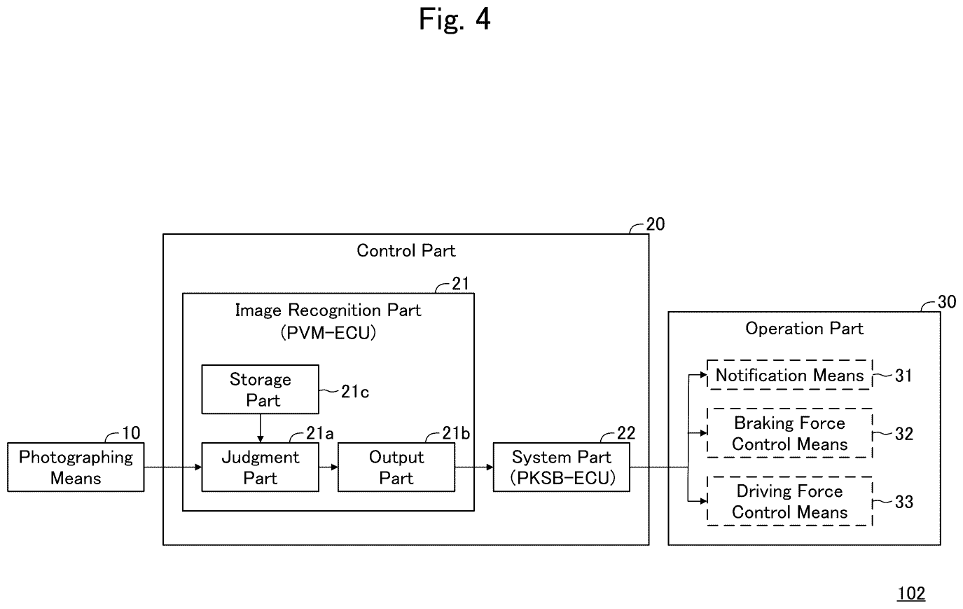

FIG. 4 is a schematic block diagram for showing an example of a functional configuration of a second apparatus. The second apparatus 102 exemplified in FIG. 4 has the same configuration as the first apparatus 101 exemplified in FIG. 2, except that the image recognition part 21 further comprises a storage part 21c which previously stores memory images which are photographed images photographed by the photographing means when the side mirrors are in the closed state (namely, the second state).

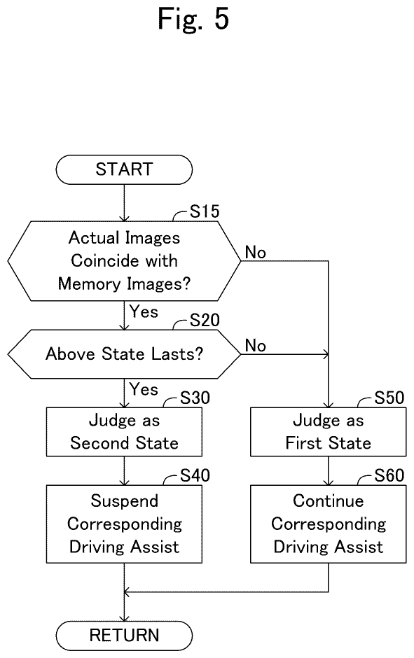

FIG. 5 is a flow chart for showing an example of a flow of various processing in a routine for performing the above-mentioned functions in the second apparatus. The flow chart exemplified in FIG. 5 is the same as the flow chart exemplified in FIG. 3 for showing a routine carried out in the first apparatus 101, except that Step S10 in which it is judged whether the side mirrors are in the closed state or not based on the photographed images photographed by the photographing means 10 is replaced with Step S15 in which it is judged whether the actual images coincide with the memory images or not. Namely, in the second apparatus 102, the judgment part 21a is configured so as to judge that the side mirrors are in the second state when the actual images are judged to coincide with the memory images and judge that the side mirrors are in the first state when the actual images are judged not to coincide with the memory images.

In the second apparatus according to a preferable aspect, the judgment part is configured so as to judge whether the actual images coincide with the memory images based on a contrast in a region corresponding to a body of the self-vehicle. The “region corresponding to a body of the self-vehicle” is the portion surrounded by a thick broken line drawn in FIG. 1, for example.

<Effects>

As mentioned above, in the second apparatus, whether the side mirrors are in the first state or in the second state is judged according to whether the memory images which are photographed images photographed by the photographing means when the side mirrors are in the second state coincide with the actual images which are photographed images photographed by the photographing means or not. Therefore, in accordance with the second apparatus, even in a situation where the opening-and-closing state of the side mirrors cannot be specified based on the signal corresponding to the state of the opening-and-closing switch of the side mirrors, the opening-and-closing state of the side mirrors can be judged more appropriately. As a result, propriety of the driving assist using the photographed images by the side cameras mounted in the side mirrors can be more appropriately notified to a driver and continuation or suspension of the driving assist can be performed more appropriately.

Although some embodiments and modifications which have specific configurations have been explained, sometimes referring to accompanying drawings, as the above, for the purpose of explaining the present invention, it should not be interpreted that the scope of the present invention is limited to these exemplary embodiments and modifications, and it is needless to say that modifications can be properly added within the limits of the matter described in the claims and the specification. For example, the present invention can be applied to an autonomous vehicle.

### REFERENCE SIGNS LIST

101,102: Driving Assist Apparatus
10: Photographing Means
20: Control Part
   21: Image Recognition Part
      21a: Judgment Part
      21b: Output Part
   22: System Part
30: Operation Part
   31: Notification Means
   32: Braking Force Control Means
   33: Driving Force Control Means

1. A driving assist apparatus comprising;
photographing means which are mounted in side mirrors which can be opened and closed between a first state where a driver can visually recognize a rear side of a self-vehicle and a second state where a protruding margin of said side mirrors in a width direction of said self-vehicle is small and photograph surrounding of said self-vehicle, and whose photographable areas are different between in said first state and in said second state, and
a control part which performs a driving assist for said driver based on photographed images photographed by said photographing means,
wherein:
said control part comprises a judgment part which judges whether said side mirrors are in said first state or in said second state based on said photographed images, and
said control part is configured so as to continue said driving assist when said side mirrors are judged to be in said first state and suspend said driving assist and notify to said driver that said driving assist is not carried out when said side mirrors are judged to be in said second state.

2. The driving assist apparatus according to claim 1, wherein:
said driving assist apparatus further comprises a storage part which previously stores memory images which are photographed images photographed by said photographing means when said side mirrors are in said second state, and
said judgment part is configured so as to judge that said side mirrors are in said second state when actual images which are photographed images photographed by said photographing means are judged to coincide with said memory images and judge that said side mirrors are in said first state when said actual images are judged not to coincide with said memory images.

3. The driving assist apparatus according to claim 2, wherein:
said judgment part is configured so as to judge whether said actual images coincide with said memory images based on a contrast in a region corresponding to a body of said self-vehicle.
